(19) United States
(12) Patent Application Publication
(10) Pub. No.: US 2006/0261635 A1
(43) Pub. Date: Nov. 23, 2006

(54) Automobile door assemblies

(76) Inventors: Jay Winborn, Berkley, MI (US); Keith Ruedisueli, Rochester Hills, MI (US); Mike Robert Blanchard, (US)

Correspondence Address: BUTZEL LONG, 350 SOUTH MAIN STREET, SUITE 300, ANN ARBOR, MI, 48104, US

(21) Appl. No.: 11/239,993

(22) Filed: Sep. 30, 2005

Related U.S. Application Data
(63) Continuation-in-part of application No. 11/134,942, filed on May 23, 2005.
(63) Continuation-in-part of application No. 11/214,483, filed on Aug. 29, 2005.

(51) Int. Cl. B60J 5/00

(52) U.S. Cl. 296/154

(57) ABSTRACT

Improved water and/or acoustic and/or thermal barrier panels for a motor vehicle door assembly that either include an impact pusher integrally formed therewith or are formed with a pocket to receive impact pushers. The integrally formed impact pusher is made of the same material as the water and/or acoustic and/or thermal barrier panel. The water and/or acoustic and/or thermal barrier panel formed with a pocket to receive impact pushers allows for the impact pushers to be attached by an adhesive or mechanically.

### RELATED APPLICATIONS

The present application is a Continuation-In-Part of U.S. patent application Ser. No. 11/134,942, filed May 23, 2005 entitled “Automobile Door Assemblies” and of U.S. patent application Ser. No. 11/214,483, filed Aug. 29, 2005, entitled “Multi-Sheet Barrier Panel for Automobile Door Assemblies,” to each of which priority is claimed under 35 U.S.C. §120 and of each of which the entire specification is hereby expressly incorporated by reference.

### TECHNICAL FIELD

The present invention relates to vehicle door water and/or acoustic and/or thermal barrier panels which prevent the ingress of water, sound, dust and air into a vehicle passenger compartment and to impact pushers which help direct vehicle occupants away from the area of impact on collision. More particularly, according to one embodiment, the present invention relates to water and/or acoustic and/or thermal barrier panels for vehicle door assemblies that include an integral water and/or acoustic and/or thermal barrier panel formed in part to serve as an impact pusher. According to another embodiment, the present invention relates to water and/or acoustic and/or thermal barrier panels for vehicle door assemblies which include impact pushers adhered to pockets formed in the water and/or acoustic and/or thermal barrier panels.

### BACKGROUND ART

Automobile door assemblies generally include a door panel to which an inner trim panel is joined. The door panel includes a cavity within which the door window may be lowered. This cavity may also contain window regulating equipment, door locks, sound speakers, air bag systems, and the like. The inner trim panel is typically a rigid or semi-rigid panel formed of a cloth-like or plastic trim material which serves as the interior passenger compartment panel.

Door assemblies are susceptible to the ingress of water which can enter into door cavities through the openings through which the door windows slide. Holes are generally formed in the bottom of door assemblies to allow any water that enters the door cavities to drain out. However, as water enters door cavities and runs down toward the drain holes, it can seep into and through the inner trim panels unless a barrier of some type is provided in the assembly.

In order to protect inner trim panels from becoming wet and possibly stained or otherwise damaged, it is common to attach panel liners over door panels beneath inner trim panels. Such panel liners are often made of a treated paper material or can comprise a thin plastic film. The panel liners function to deflect any water entering door cavities so that the water runs down the liners to the bottoms of the door cavities without contacting the inner trim panels.

Door assemblies are sometimes provided with sound-dampening materials for decreasing the amount of noise that enters the car. Traveling along the roads at high speeds frequently generates what is commonly known as road noise which leads to loud and distracting background noise in the vehicle due to noise created by the tires as they travel over a surface and by the wind as it encounters the moving vehicle. Decreasing the volume of such road noise can be achieved at least in part by including layers of sound-dampening materials within the door assemblies of the vehicle.

Door assemblies are also sometimes reinforced with foam blocks that are adhered to structural panels, including interior panels and/or outer door panels. In some instances, these foam blocks function as impact pushers by pushing a vehicle occupant away from the door in the event of a collision or other impact on the side of the vehicle, thereby preventing harm to the vehicle occupant. The foam blocks are usually made of polystyrene and are placed within the door assembly according to the shape of the door and the relative placement of the nearest occupant's seat so as to provide maximal impact protection. Often this places the impact pusher near the hip of the vehicle occupant.

Patents that disclose door assemblies having foam blocks U.S. Pat. No. 3,989,275 to Finch, et al.; U.S. Pat. No. 4,786,100 to Kleemann, et al.; U.S. Pat. No. 5,040,335 to Grimes; U.S. Pat. No. 5,395,135 to Lim, et al.; U.S. Pat. No. 5,433,478 to Naruse; U.S. Pat. No. 5,482,344 to Walker, et al.; U.S. Pat. No. 5,573,272 to Teshima; U.S. Pat. No. 5,573,298 to Walker, et al.; U.S. Pat. No. 5,603,548 to Gandhi, et al.; U.S. Pat. No. 5,636,866 to Suzuki, et al.; U.S. Pat. No. 5,749,600 to Yamada, et al.; U.S. Pat. No. 5,857,702 to Suga, et al.; U.S. Pat. No. 5,934,730 to Yagishita, et al.; U.S. Pat. No. 6,357,812 to Adachi, et al.; U.S. Pat. No. 6,481,776 to Adachi, et al.; U.S. Pat. No. 6,543,838 to Bertolini, et al.; U.S. Pat. No. 6,808,224 to Obara; and U.S. Pat. No. 6,863,335 to Lopez Torres, et al. in addition to U.S. Pat. Publication Nos. 2001/0017476 to Nishikawa, et al.; 2002/0089205 to Adachi, et al.; and 2004/0251712 Obara.

According to one embodiment, the present invention provides water and/or acoustic and/or thermal barrier panels for vehicle door assemblies that comprise water and/or acoustic and/or thermal insulation barrier panels having one or more integrally formed portion(s) that functions an impact pusher. According to another embodiment, the present invention provides water and/or acoustic and/or thermal barrier panels for vehicle door assemblies that include impact pushers attached to pockets formed in the barrier panels.

### DISCLOSURE OF THE INVENTION

According to various features, characteristics and embodiments of the present invention which will become apparent as the description thereof proceeds, the present invention provides a barrier liner for a vehicle door assembly having a door panel which comprises:
a barrier panel having at least one of a water impermeability and an insulting characteristic; and
at least one impact pusher integrally formed with the barrier panel.

The present invention further provides a barrier liner for a vehicle door assembly which comprises:
a barrier panel having at least one of a water impermeability and an insulating characteristic formed with at least one pocket to receive an impact pusher; and
at least one impact pusher positioned in the at least one pocket.

The present invention also provides a method of making vehicle door assemblies which comprises:
providing a door panel;
providing a barrier liner that includes a barrier panel having at least one of a water impermeability and an insulating characteristic and at least one impact pusher;
integrally forming the at least one impact pusher and the barrier panel in one operation; and
attaching the barrier liner to the door panel.

The present invention further provides a method of making vehicle door assemblies comprising:
providing a door panel;
providing a barrier liner that includes barrier panel having at least one of a water impermeability and an insulating characteristic with at least one pocket formed therein
providing an impact pusher;
attaching the impact pusher to the at least one pocket of the barrier panel; and
attaching the barrier liner to the door panel.

### BRIEF DESCRIPTION OF DRAWINGS

The present invention will be described with reference to the attached drawings which are given as non-limiting examples only, in which:

FIG. 1 is an elevational view of a barrier panel and impact pusher according to one embodiment of the present invention.

FIG. 2 is a sectional view of a barrier panel and impact pusher taken along line 2-2 in FIG. 1.

FIG. 3 is an elevational view of a barrier panel and impact pusher according to one embodiment of the present invention.

FIG. 4 is a sectional view of a barrier panel and impact pusher taken along section line 4-4 in FIG. 3.

FIG. 5 is an elevational view of a barrier panel and impact pusher according to one embodiment of the present invention.

FIG. 6 is a sectional view of a barrier panel and impact pusher taken along section line 6-6 in FIG. 5.

FIG. 7 is an elevational view of a barrier panel and impact pusher according to one embodiment of the present invention.

FIG. 8 is a sectional view of a barrier panel and impact pusher taken along section line 8-8 in FIG. 7.

FIG. 9 is an enlarged view of the encircled portion “9” of the barrier panel and impact pusher illustrated in FIG. 8.

### BEST MODE FOR CARRYING OUT THE INVENTION

According to one embodiment, the present invention is directed to water and/or insulating barrier panels for vehicle door assemblies that have an integrally configured structure or structures that function as impact pushers or that are integrally configured to receive and secure therein impact pushers. The barrier panels of the present invention can be configured and designed to provide acoustic and/or thermal insulation. The barrier panels of the present invention are configured to be received between an inner trim panel and a door panel of a door assembly and to provide a peripheral seal against the door panel which effectively prevents water damage to the inner trim panel. The barrier panels may be formed, e.g. molded, from single-sheets of various materials. When formed from two or more sheets, the adjacent sheets can be bonded together at discrete locations and areas in the space between adjacent sheets can be hollow or can contain or be filled with acoustic and/or thermal insulation materials such as noise absorbing material or materials with low thermal conductivity.

The barrier panels can be secured to door panels in door assemblies using conventional mechanical fasteners. Alternatively, the barrier panels can include engaging structures provided on the outboard sides thereof which are aligned and configured to engage one or more openings provided in the inboard side of the door panel. The barrier panels of the present invention generally comprise one or more sheets of material and have a configuration that is complementary shaped to the inner or inboard surface of a door panel at least around the periphery thereof. The material from which the barrier panels are made is substantially impermeable to water and preferably provides insulation against sound from the road and/or temperatures outside the vehicle. The barrier panels also form or provide supported impact pushers.

The impact pusher can be made from the same material as the barrier panel and can be integrally formed, e.g. molded therewith to provide a unitary structure. Alternatively, the impact pusher can be formed from a material that is different or has a different physical property, e.g., density, compressibility, etc. from the barrier panel and co-molded thereon. Suitable materials from which the barrier panels can be made include polyethylene, polystyrene, ABS plastics, polypropylene, thermal plastics, foamable plastics, ABS plastics, rubber, carbon fiber, lightweight aluminum alloy, steel, etc. The impact pushers, when made separately and incorporated into the barrier panel can be molded from impact absorbing materials such as polystyrene foams, or similar materials. Hard foams such as polystyrene foams are particularly suitable for purposes of the present invention due to the fact that such hard, densely packed foam that can withstand impacts and still remain able to push against a vehicle occupant with a small amount of elasticity.

According to the invention one or more impact pushers are formed integral to the barrier panels in a location such that the impact pusher(s) will be positioned to push a vehicle occupant away from an impact to the door assembly once the door assembly is included with a vehicle. The impact pusher can be of many different sizes and shapes. The optimal size and shape of the impact pusher will depend upon the type, weight, size, and other impact protective measures in place on any particular type of vehicle. For example, an impact pusher in a large sport utility vehicle may be of a larger size than an impact pusher for a small sedan. Placement of the impact pusher within the space defined by the barrier will also depend upon the placement of seats within the vehicle relative to the placement of the door assembly. For example, vehicles where the seats may be closer to the floor of the vehicle will require placement of the impact pusher closer to the floor of the vehicle as well. Although the barrier panels are generally discussed as providing a water barrier and acoustic and/or a thermal insulation barrier, reference to “barrier” panels more generally encompasses the ability of the panels to provide a barrier against dirt, dust and air from transgressing through a car door assembly.

The use of an impact pusher that is integrally formed with a water and/or acoustic and/or thermal barrier panel eliminates the additional manufacturing step of securing an impact pusher in a door assembly and can reduce the number of elements in a door panel assembly. Moreover, having the impact pusher formed integrally with the barrier panels of the present invention allows for simultaneous assembly of the barrier panels and the impact pushers. The integral formation of the parts also increases the stability of the parts as a whole, improving the likelihood that the impact pusher will remain in position and push a vehicle occupant away from an impact. If one material is used to form both the barrier panel and the impact pusher there is also a savings in material use and management to create the door assembly.

Features and characteristics of the present invention will be hereafter described with reference to the attached drawings which are provided as non-limiting examples only. Throughout the drawings, similar reference numerals are used to identify common elements when possible in order to simplify the description.

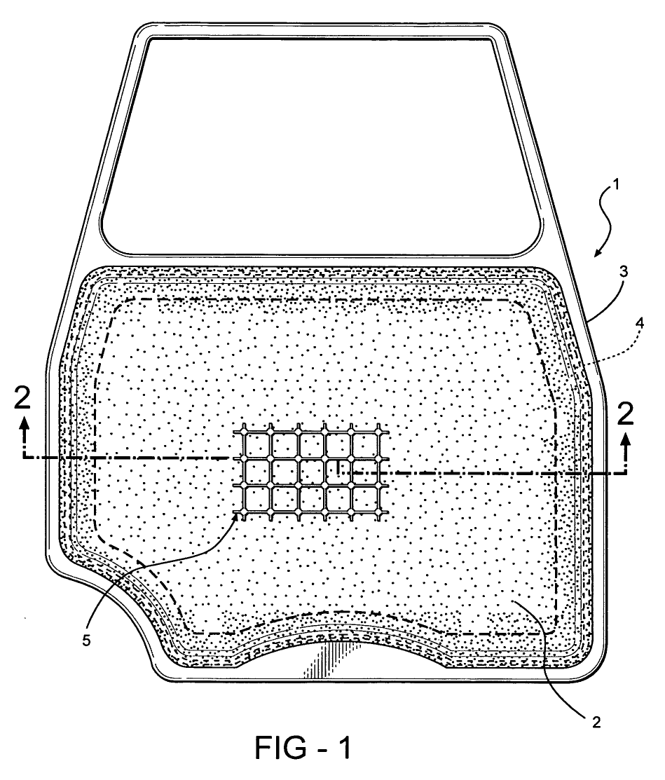

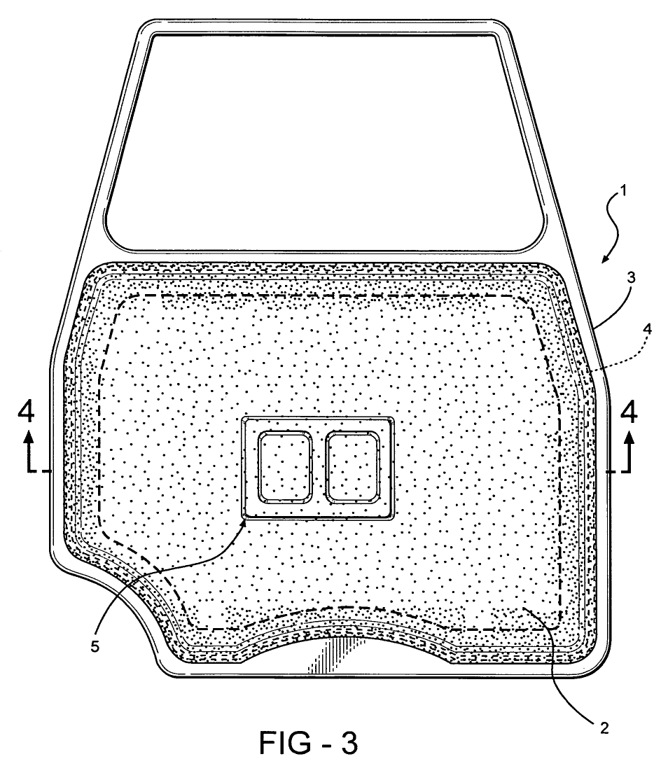

FIGS. 1 and 3 are elevational views of door assemblies including a water and/or acoustic and/or thermal barrier panel and impact pusher according to embodiments of the present invention. The door assembly 1 includes a barrier panel 3 that attaches to the door panel 3 using, for example, mechanical fasteners (not shown) or engaging structures that are formed on the outboard side of the barrier panel 2. A adhesive bead 4 is provided along the peripheral edge of the barrier panel 2 for sealing out water and moisture. The barrier panel 2 may also be attached to the door panel 3 using any other adhesive or mechanical means of ensuring the adjacent positioning of the barrier panel 2 and the door panel 5. The barrier panel 2 includes a generally planar sheet that has been molded (not shown) so as to include areas that are configured to conform to, receive or accommodate various components of a vehicle door such as a door latching handle, window control mechanism, power seat control panel, etc. (none shown).

An impact pusher 5 is also included with the barrier panel 2 in FIGS. 1 and 3 and can be injection-molded, vacuum-molded, thermoformed or otherwise formed to be integral with the barrier panel 3. The process of injection-molding, vacuum-molding, thermoforming or otherwise forming the impact pusher 5 and barrier panel 2 simultaneously requires the production of only one piece to form both the impact pusher 5 and barrier panel 3. While the impact pusher 5 on the barrier panel 2 in FIGS. 1 and 3 are shown as being disposed near the center of the door assembly 1, these are but illustrative positions, and, as mentioned above, the impact pusher 5 may be located in other positions depending on the location that best suits the vehicle into which the door assembly 1 will be placed. In FIG. 1 the impact pusher 5 has a rectangular honey-comb structure and is integral with the barrier panel 3. In FIG. 3 the impact pusher 5 has a generally sideways figure-8 structure integral with the barrier panel 3. These are but two examples of the various shapes the impact pusher 5 can take and it is to be understood that the impact pusher 5 could also be solid, rectangular, kidney-shaped, circular, s-shaped, etc. As noted above, the shape of the impact pusher can be varied according to the use for which it is intended. Moreover, the impact pusher 5 may be composed of two or more separate pieces that together form the impact pusher 8.

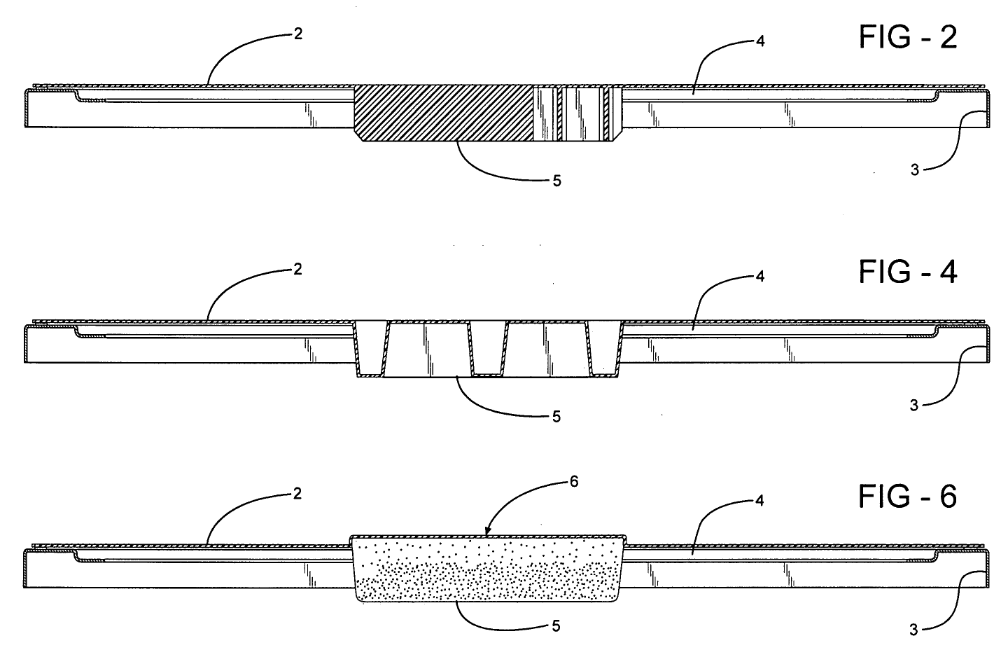

FIGS. 2 and 4 are sectional views of a barrier panel and impact pusher taken along line 2-2 in FIG. 1 and along line 4-4 in FIG. 3. The barrier panel 2 is generally planar and is attached to the door panel 3 using mechanical fasteners (not shown) or by engaging structures that are formed on the outboard side of the barrier panel 3. An adhesive bead 4 is provided along the periphery of the barrier panel 1 and is used to seal out water and moisture. The impact pusher 5 extends outward in a manner perpendicular to the barrier panel 2 and away from the inboard side of barrier panel 3. The distance the impact pusher 5 extends out from the barrier panel 3, as discussed above, will vary according to the needs of the vehicle in which the door assembly 1 is placed, and the depth of the impact pusher 5 here is but a non-limiting example. As shown in FIG. 2 the impact pusher 5 may take a honey-comb shape. FIG. 4 illustrates an impact pusher 5 having a generally sideways figure-8 shape. FIGS. 2 and 4 are non-limiting illustrations of only two of the many possible embodiments and configurations that the impact pusher 5 may take.

According to another embodiment, the present invention relates to barrier panels for vehicle door assemblies which include impact pushers positioned in pockets formed in the barrier panels. This embodiment of the present invention requires the attachment of the impact pusher to the barrier panels after the barrier panels are created. Each barrier panel is formed with one or more pockets. These pockets are designed to receive impact pushers and are to be shaped complementary to the shape of the impact pusher. As discussed above, the shape and size of impact pushers will depend upon the vehicle in which the door assembly will be included. The size and shape of the pockets in the barrier panels will therefore also vary depending upon the vehicle in which the door assembly is to be included. The pockets formed in the barrier panels may also vary in depth. The depth of the pocket(s) will also vary depending upon the type of vehicle and the resulting size and shape of the impact pusher that will be included in the door assembly.

The pocket(s) in the barrier panels can be formed during the process of forming, e.g. molding, the barrier panels. The pocket(s) can be made from the same material used in the formation of the barrier panels. Once the barrier panels are formed with the pockets, the impact pushers can be adhered to the barrier panels within the pockets. The impact pushers can be adhered in the pockets, for example, by using any adhesive common in the industry which can be applied as a bead that extends along the periphery of the impact pushers or as a continuous layer or in any discrete pattern. Other means of adhering the impact pusher to the barrier panels can be used including, for example, thermal or ultrasonic welding, mechanical fasteners, cooperating engaging structures, epoxies, etc. It is also possible to configure the impact pushers and the walls of the pockets with cooperating engaging structures by which the impact pushers can be secured in the pockets.

In this embodiment of the present invention the impact pushers are secured to the barrier panels by adhesives while the pocket in the barrier panels ensures that assembly will take less time due to the ease of correctly placing the impact pusher into the pocket on the barrier panels. Accordingly, the assembly time for the door assemblies will decrease and placement of the impact pusher will be correct for each and every door assembly without the requirement of measurements or a visual review of the assembly to determine correct placement.

The barrier panels of the present invention can be made from any suitable material such as, for example, polyethylene, polystyrene, ABS plastics, polypropylene, thermal plastics, foamable plastics, etc. Materials such as polyolefin foams including cross-linked polyethylene or polypropylene foams will function both as moisture barriers and sound barriers. The barrier panel can have a thickness of from about 0.02 inches to about 2.00 inches and preferably from about 0.04 inches to about 0.35 inches. The impact pushers can be made from polystyrene foam or any other similarly hard foam that can withstand an impact such as would be received by a vehicle in a collision.

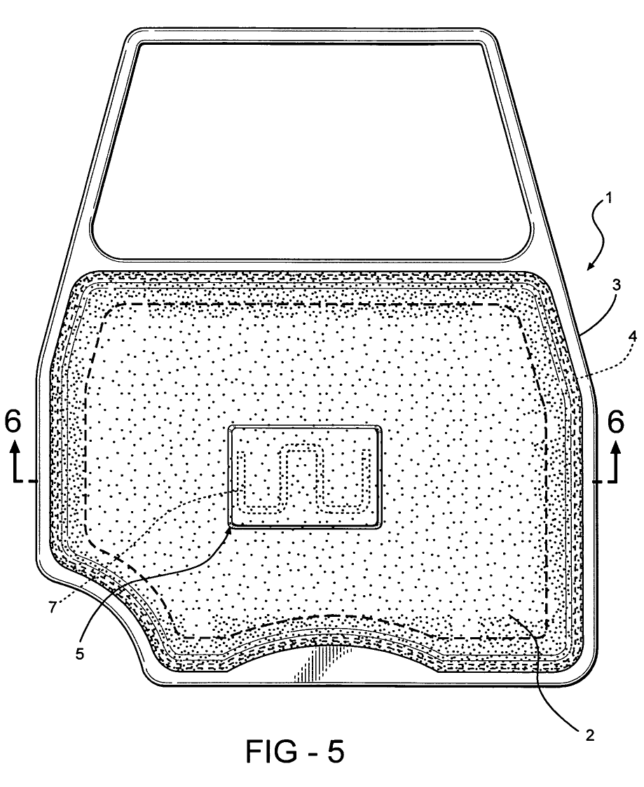

FIG. 5 is an elevational view of a door assembly according to an embodiment of the present invention including a barrier panel and impact pusher according to the present invention. The door assembly 1 includes a barrier panel 2 that attaches to the door panel 3 using, for example, mechanical fasteners (not shown) or engaging structures provided on the outboard side of the barrier panel 3. An adhesive bead 4 is provided along the peripheral edge of the barrier panel 2 to seal out water and moisture. The barrier panel 2 may also attach to the door panel 3 using any other adhesive or mechanical means of ensuring the adjacent positioning of the barrier panel 2 and the door panel 5. The barrier panel 2 includes a generally planar sheet that has been molded to include one or more pockets 9 (one shown) in which the impact pusher 5 will be placed. This pocket 6 may be shaped to receive multiple different shapes of impact pushers 8 or impact pushers 8 comprising two or more parts. The barrier panel 2 also includes a generally planar sheet that has been molded (not shown) so as to include areas that are configured to conform to, receive or accommodate various components of a vehicle door such as a door latching handle, window control mechanism, power seat control panel, etc. (none shown).

An impact pusher 5 is also included with the barrier panel 2 and is to be adhered thereto using an adhesive bead 7. Other means of attaching the impact pusher 5 to the barrier panel are discussed above and include mechanical fasteners, epoxies, or other adhesives and cooperative engaging structures formed on the impact pushers 5 and the walls of the pockets 6. The process of placing the impact pusher 5 into the pocket 6 formed in the barrier panel 2 requires less work in assembly and a more stable placement of the impact pusher 5 in the door assembly 1. While the impact pusher 5 in the pocket 6 on the barrier panel 2 in FIG. 5 is shown as being disposed near the center of the door assembly 1, this is but an example, and, as mentioned above, the impact pusher 5 may be repositioned depending on the location that best suits the vehicle into which the door assembly 1 will be placed.

FIG. 6 is a sectional view of a barrier panel and impact pusher taken along line 6-6 in FIG. 5. The barrier panel 2 is generally planar with the exception of the pocket 6 and is attached to the door panel 3 using mechanical fasteners (not shown) or engaging structures provided on the outboard surface of the barrier panel 3. An adhesive bead 4 is provided along the periphery of the barrier panel 2 to seal out water and moisture. The impact pusher 8, once attached to the barrier 3, extends out in a manner perpendicular to the inboard side of barrier panel 2 and away from the barrier panel 3. The distance the impact pusher 5 extends out from the barrier panel 3, as discussed above, will vary according to the needs of the vehicle in which the door assembly 1 is placed, and the depth of the impact pusher 5 here is but an example. As shown in FIG. 6 the impact pusher 5 may be a solid rectangular block of foam or other type of suitable material. The impact pusher 8, however, may also take various other shapes, as discussed above with reference to FIGS. 1-4, and may be comprised of two or more separate parts.

It is to be understood that both the barrier panel 2 and the impact pusher 5 in all embodiments herein can be made from a polystyrene foam, for example, or any similar material that is hard and will function as a moisture and sound barrier. It is further to be understood that the barrier panel of the embodiment disclosed in FIGS. 5 and 6 can be made from a polyolefin foam, for example a cross-linked polyethylene or polypropylene foam or any similar material that will function as a water and sound barrier. The barrier panel 2 of the present invention can have a thickness of from about 0.02 inches to about 2.00 inches and preferably from about 0.04 inches to about 0.35 inches. The impact pusher of the present invention can have a thickness of from about 0.5 inches to about 4.0 inches, with the preferred thickness determined for each vehicle based on the size and attributes of each individual type of vehicle.

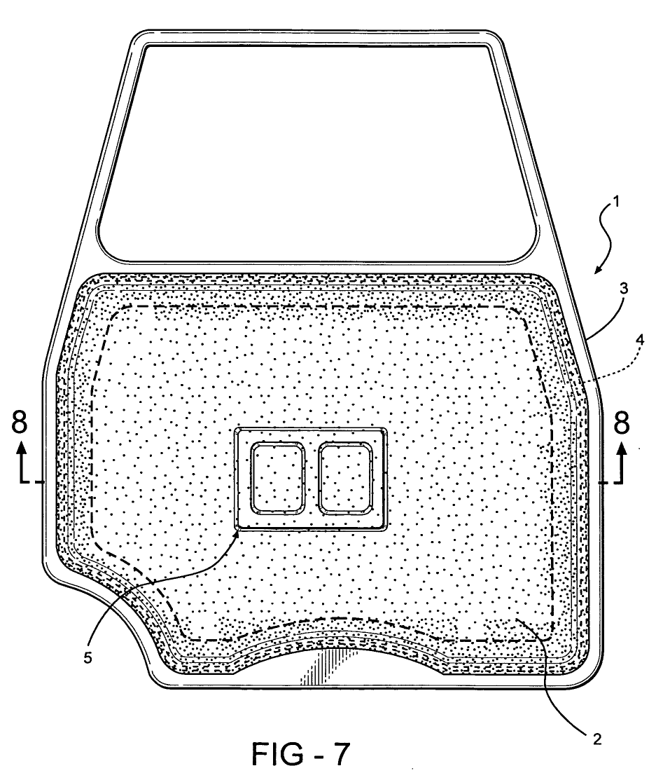

FIG. 7 is an elevational view of a door assembly including a water and/or acoustic and/or thermal barrier panel and impact pusher according to an embodiment of the present invention. The door assembly 1 includes multiple sheets of barrier panels 2 that attach to the door panel 3 using, for example, mechanical fasteners (not shown) or engaging structures that are formed on the outboard side of the barrier panel 2. A adhesive bead 4 is provided along the peripheral edge of the barrier panel 2 for sealing out water and moisture. The barrier panel 2 may also be attached to the door panel 3 using any other adhesive or mechanical means of ensuring the adjacent positioning of the barrier panel 2 and the door panel 5. An impact pusher 5 is also included with the barrier panel 2 in FIG. 7 and can be injection-molded, vacuum-molded, thermoformed or otherwise formed to be integral with the barrier panel 3. The impact pusher 5 may also be attached to the multiple sheet barrier panel 2 of FIG. 7 using an adhesive or fastening it on by mechanical fasteners. The multiple sheet barrier panel 2 structure of FIG. 7 is but an example and additional sheets of barrier panel 2 may be added in different configurations and to allow different spaces between the sheets of barrier panel 3.

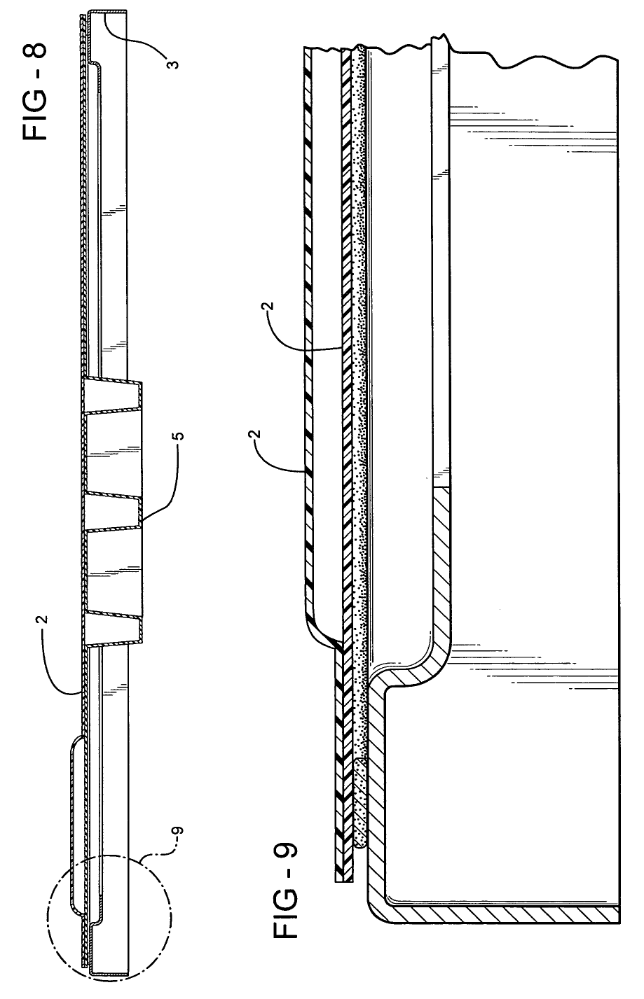

FIG. 8 is a sectional view of a barrier panel and impact pusher taken along section line 8-8 in FIG. 7. The barrier panels 2 are generally planar and are attached to one another either directly or at various contact points to create space between the barrier panels 3. The barrier panels 2 may be attached to one another using mechanical fasteners (not shown) or by engaging structures that are formed on the barrier panel 3. The barrier panels 2 may be bonded together at discrete locations and areas in the space between the adjacent barrier panels 2 can be hollow or can contain or be filled with acoustic and/or thermal insulation materials such as noise absorbing materials or materials with low thermal conductivity. The innermost barrier panel 2 may be attached to the door panel 3 by an adhesive bead 4 provided along the periphery of the barrier panel 2 and is used to seal out water and moisture. The impact pusher 5 extends outward in a manner perpendicular to the barrier panels 2 and away from the inboard side of barrier panels 3. The distance the impact pusher 5 extends out from the barrier panel 3, as discussed above, will vary according to the needs of the vehicle in which the door assembly 1 is placed, and the depth of the impact pusher 5 here is but a non-limiting example. FIG. 8 is a non-limiting illustration of only one of the many possible embodiments and configurations that the multiple sheets of barrier panels 2 may take.

FIG. 9 is an enlarged view of the encircled portion “9” of the barrier panel and impact pusher illustrated in FIG. 8. As can be seen best in FIG. 9, the multiple sheet barrier panel 2 comprises two barrier panels, including an outer sheet and an inner sheet. It can be seen in FIG. 9 that in some places the barrier panels 2 are in direct contact with one another and in other places the barrier panels 2 are apart to create an open space between them. An acoustic and/or thermal insulation material may be inserted in this space created between the barrier panels 3. Such insulating materials can be provided at discrete locations between the inner and outer sheets or completely throughout the space or chamber(s) formed between the inner and out sheets. The insulating material can comprise any suitable material that provides for acoustic and/or thermal insulation including, but not limited to, thermoplastic polymers and elastomers, including polyethylene, polypropylene, polybutenes, polyisoprene and their copolymers. These materials can be functionalized according to known manners by, for example, controlling their densities, cellular structures and/or incorporating fillers to improve their acoustic and/or thermal insulating properties. For purposes of the present invention, polyethylene therephthalate, and Thinsulate™ acoustic insulation were determined to generally suitable for use as insulation materials. The common perimeter of the barrier panels 2 can be fused or otherwise sealed together to increase the insulation properties and structural strength of the multi-sheet barrier panels.

Vehicle doors may be assembled using the barrier panels and impact pushers described according to embodiments of the present invention. To assemble vehicle doors according one embodiment of the present invention first a barrier panel is formed integral with an impact pusher. The barrier panel having the impact pusher formed integrally therewith can then be attached to a door panel using any conventional mechanical fastening means or engaging structures provided on the outboard surface of the barrier panel. According to another embodiment of the invention the barrier is formed with a pocket to receive an impact pusher and an impact pusher is formed separately. According to this embodiment the impact pusher is attached to the pocket of the barrier and the attached impact pusher and barrier panel are attached to a door panel.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above.

What is claimed is:

1. A barrier liner for a vehicle door assembly which comprises:
a barrier panel having at least one of a water impermeability and an insulating characteristic; and
at least one impact pusher integrally formed with the barrier panel.

2. A barrier liner for a vehicle door assembly according to claim 1, wherein the barrier panel barrier panel has at least one of an acoustic and a thermal insulating characteristic.

3. A barrier liner for a vehicle door assembly according to claim 1, wherein the barrier panel and the at least one impact pusher are made from the same material.

4. A barrier liner for a vehicle door assembly according to claim 1, wherein the barrier panel and the at least one impact pusher are molded together to be integral.

5. A barrier liner for a vehicle door assembly according to claim 1, wherein the barrier panel and the at least one impact pusher are injection-molded.

6. A barrier liner for a vehicle door assembly according to claim 1, wherein the barrier panel and the at least one impact pusher are thermoformed.

7. A barrier liner for a vehicle door assembly according to claim 1, wherein the barrier panel and the at least one impact pusher are made from a polystyrene foam.

8. The barrier liner of claim 1 in combination with a door assembly for a motor vehicle which includes a door panel attached to the barrier panel with which the at least one impact pusher is integrally formed.

9. A barrier liner for a vehicle door assembly comprising:
a barrier panel having at least one of a water impermeability and an insulating characteristic formed with at least one pocket to receive an impact pusher; and
an impact pusher positioned in the at least one pocket.

10. A barrier liner for a vehicle door assembly according to claim 9, wherein the impact pusher is attached to the barrier panel by an adhesive.

11. A barrier liner for a vehicle door assembly according to claim 9, wherein the impact pusher is made from a polystyrene foam.

12. A barrier liner for a vehicle door assembly according to claim 9, wherein the at least one pocket formed in the barrier panel is substantially complimentary to the shape of the impact pusher.

13. A barrier liner for a vehicle door assembly according to claim 9, wherein the at least one pocket formed in the barrier panel is placed on the vehicle door assembly in a location where it will be in a position to push a vehicle occupant.

14. The barrier liner of claim 9 in combination with a door assembly for a motor vehicle which includes a door panel attached to the barrier panel with the at least one pocket in which the impact pusher is positioned.

15. A method of making vehicle door assemblies comprising:
providing a door panel;
providing a barrier liner that includes a barrier panel having at least one of a water impermeability and an insulating characteristic and at least one impact pusher;
integrally forming the at least one impact pusher and the barrier panel in one operation; and
attaching the barrier liner to the door panel.

16. The method of claim 15 wherein the barrier liner is attached to the door panel using mechanical fasteners.

17. The method of claim 15 wherein the barrier liner is attached to the door panel using an adhesive.

18. A method of making vehicle door assemblies comprising:
providing a door panel;
providing a barrier liner that includes barrier panel having at least one of a water impermeability and an insulating characteristic with at least one pocket formed therein providing an impact pusher;
attaching the impact pusher to the at least one pocket of the barrier panel; and
attaching the barrier liner to the door panel.

19. The method of claim 18 wherein the impact pusher is attached to the barrier panel using an adhesive.

21. The method of claim 18 wherein the barrier liner is attached to the door panel using mechanical fasteners.

22. The method of claim 18 wherein the barrier liner is attached to the door panel using an adhesive.
